(19) United States
(12) Patent Application Publication
(10) Pub. No.: US 2019/0193913 A1
(43) Pub. Date: Jun. 27, 2019

(54) HYDROGEN GENERATOR FOR BEVERAGES

(71) Applicant: Takashi TAKEHARA, Osaka-shi, Osaka (JP)

(72) Inventor: Takashi TAKEHARA, Osaka-shi, Osaka (JP)

(21) Appl. No.: 16/306,481

(22) PCT Filed: Sep. 8, 2017
(86) PCT No.: PCT/JP2017/032565

§ 371 Date: Nov. 30, 2018

(30) Foreign Application Priority Data
Sep. 11, 2016 (JP) 2016-177194

(51) Int. Cl. B65D 81/32; A23L 2/54; C02F 1/68

(52) U.S. Cl. CPC B65D 81/32; A23V 2002/00; C02F 1/685; A23L 2/54

(57) ABSTRACT

Provided is a hydrogen generator for beverages which can be attached to a beverage container for adding hydrogen to beverages and obtaining beverages containing hydrogen. The present hydrogen generator for beverages includes an approximately tubular ampule member which seals an aqueous solution having water as a main composition in an inner portion thereof and extends in a longitudinal direction, and an approximately tubular outer coat member which seals the ampule member and a metal material making hydrogen generation reaction with water in an inner portion thereof, is constructed by a raw material having a higher flexibility than the ampule member and extends in the longitudinal direction of the ampule member, and the ampule member is ruptured with a hand power in a lateral direction of the ampule member when using.

### TECHNICAL FIELD

The present invention relates to a hydrogen generator for beverages for obtaining a beverage containing hydrogen by adding the hydrogen to the beverage without including any water pouring work.

### BACKGROUND ART

It has been researched that active oxygen has a very strong oxidation power, and attacks and damages human normal cells as well as having a role to removing bacteria and virus entering into the human body. The excessive presence of the active oxygen raises a possibility of damaging the normal cell, and generates a risk such as deterioration and mutation of the cell or aging of the skin and arteriosclerosis therealong.

In recent years, it has been apparent on the basis of researches that the hydrogen removes the active oxygen, and a drinking water including hydrogen (called as a hydrogen water) is gathering attention to be effective for health and beauty, the hydrogen water being capable of taking hydrogen directly in the body by drinking in. Since the reaction of hydrogen and active oxygen only generates water as a reactant, it has very small affect adversely to the human body. Therefore, it is suggested to take in the hydrogen water for preventing aging in various situation, when the human body is exposed to a high stress, in which active oxygen particularly tends to be generated in the body, such as during exercise, during eating and drinking, during smoking, during staying under ultraviolet light and contaminated environment, lack of sleep, and working long hours and for promoting beauty and health.

Actually, in the case of taking in the hydrogen water as the beverage every day, the beverage is required first of all to have no drug toxicity to the human body or no health damage to the human body. Further, taking convenience into consideration, a size which can be easily taken in and easily carried with is desired. Further, since hydrogen can pass through a container made of a polymer raw material such as a plastic bottle and can react with a beverage composition in the container, there is a problem that hydrogen included in the beverage within the container is reduced with time. On the contrary, there has been obtained a research result that a higher active oxygen removing effect is generated in the case that the hydrogen water is taken in at plural times than in the case that a large amount of the hydrogen water is taken in once. Accordingly, it is important and required to maintain the effect as the hydrogen water for a long period of time within the container.

In the light of the above points, there are required that any material adversely affecting the human body is not mixed into the hydrogen water when taking in the hydrogen water, the container has such a shape and size as to be portable or be easily carried, the content of hydrogen in the hydrogen water is kept just before taking in, and the effect of the hydrogen water is maintained for a long period of time within the container.

In order to solve problems mentioned above, the inventors of the present invention have developed a hydrogen generator described in patent literature 1 (hereinafter, refer to as a prior hydrogen generator). The prior hydrogen generator steadily generates hydrogen on the basis of a chemical reaction of metal and water, and dissolve the generated hydrogen into an optional beverage by directly putting the prior hydrogen generator into the beverage to be able to obtain the hydrogen water. Since the prior hydrogen generator is covered with a filter which permeates only hydrogen, any other foreign material than hydrogen is not mixed into the beverage, thereby no risk adversely affecting the human body is found. Further, the prior hydrogen generator has such a dimension that the prior hydrogen generator can be put in the existing container such as the plastic bottle container, and can be applied to any container having such a shape and size that is portable or is easily carried. Further, since the hydrogen water can be obtained by putting the prior hydrogen generator generating the hydrogen in the beverage just before taking in, a sufficient amount of hydrogen content can be kept in the beverage when taking in. Further, since the hydrogen is generated continuously until the end of reaction, the prior hydrogen generator is suitable for using for a long period of time.

However, in the prior hydrogen generator, it is essential to carry out a step of metering a predetermined amount of water, opening a lid of the prior hydrogen generator and pouring water in the prior hydrogen generator, and closing the lid of the prior hydrogen generator, as preparation for putting in the beverage. The step mentioned above is troublesome. In addition, it is necessary to prepare a member such as the lid and a water pouring device and the structure is complicated due to the restriction of the shape and the size of the member, thereby causing a problem in manufacturing. Further, since water is poured from one end of the prior hydrogen generator, it takes a long time to bring water into contact with an entire metal within the container and a sufficient amount of hydrogen cannot be secured. Therefore, the prior hydrogen generator cannot meet a need for obtaining the hydrogen rapidly and easily.

### CITATION LIST

### Patent Literature

Patent Literature 1: PCT/JP2013/083121

### SUMMARY OF INVENTION

### Technical Problems

As mentioned above, a device obtaining hydrogen water rapidly and easily while having the advantages of the prior hydrogen generation has been desired.

The present invention is made by taking the circumstances mentioned above into consideration, and an object of the present invention is to provide a hydrogen generator which can obtain hydrogen water rapidly with a further simple structure and step while keeping the advantages of the prior hydrogen generator.

### Solutions to Problems

In order to achieve the object mentioned above, a hydrogen generator for beverages according to the present invention includes:

an approximately tubular ampule member which seals an aqueous solution having water as a main composition in an inner portion thereof and extends in a longitudinal direction; and

an approximately tubular outer coat member which seals the ampule member and a metal material making hydrogen generation reaction with water in an inner portion thereof, is constructed by a raw material having a higher flexibility than the ampule member and extends in the longitudinal direction of the ampule member,

wherein a part of the outer coat member is shielded from outside by an air-permeable and water-impermeable material which shields the aqueous solution and allows passage of hydrogen, and

wherein the ampule member is ruptured with a hand power in a lateral direction of the ampule member when using.

In the hydrogen generator according to the present invention (hereinafter, refer to as the present hydrogen generator), only the ampule portion having a low flexibility in an inner portion thereof is ruptured without occurring of any rupture or tear of the outer coat member when folding a portion near a center of the approximately tubular elongated present hydrogen generator with hand power, so that all the aqueous solution sealed into the ampule portion is discharged into the outer coat member all at once. As a result, a predetermined amount of hydrogen gas is generated until the end of reaction on the basis of a chemical reaction between the aqueous solution and the metal portion sealed into the outer coat member, the hydrogen gas is discharged to the outside of the outer coat member through the air-permeable and water-impermeable material, and the other metal material and aqueous solution are left in the outer coat member. By putting the present hydrogen generator in an optional beverage in this state, the hydrogen gas dissolves in the beverage until the end of the hydrogen generation reaction and the hydrogen water can be easily obtained.

In the present hydrogen generator mentioned above, it is possible to manage the present hydrogen generator without any hydrogen generation reaction when storing and carrying, and it is possible to discharge a predetermined amount of hydrogen gas until the end of reaction only by folding the hydrogen generation tool with a hand power of the user when using. Accordingly, the present hydrogen generator has a high versatility as a disposable product which can easily form the hydrogen water for every container such as a desired bottle. Further, since the water pouring work for the hydrogen generation reaction is not necessary, the hydrogen generator is simple for the user, and any dripping is not caused when pouring water, thereby being sanitary. Further, the hydrogen generator has a simple structure obtained only by sealing the ampule member with the aqueous solution and the metal material and is advantageous in a point that the manufacturing, managing and transferring costs can be reduced.

It is desirable that the metal portion be formed into a granular material or a powdered material, an optional stereoscopic shape, a metal fixed onto a surface of a non-reactant or a combination thereof.

According to the present hydrogen generator mentioned above, it is possible to regulate an amount per time for a desired hydrogen generation, a duration and a reaction temperature in the hydrogen generation, and it is possible to obtain the hydrogen water having a desired hydrogen concentration and duration. In particular, it is possible to rapidly generate the hydrogen water in each of the containers. For example, up a case of forming into a granular shape and a case of forming a cartridge containing the metal powder can be considered.

Further, the ampule member is preferably arranged below the metal material.

The aqueous solution is always accumulated in the metal material side by installing in this order and it is possible to avoid a static state of the hydrogen gas generation.

In the metal portion, the main component of the metal chemically reacting with water is preferably any one of magnesium, aluminum, and calcium.

A thickness of the ampule portion in the vicinity of the center in the longitudinal direction has desirably a smaller structure or a lower rigidity structure than other members.

According to the present hydrogen generator mentioned above, since the hand power is applied for generally folding a portion near the center of the outer coat member when folding the present hydrogen generator, it is highly likely that a transverse load applied to the ampule portion occurs in the portion near the center. As a result, if the thickness of the portion near the center is kept small, the ampule member tends to be rapidly ruptured. Therefore, an outflow of the aqueous solution from the ampule portion into the outer coat member and therefore the reaction with the metal material are rapidly carried out by the small hand power, and the hydrogen gas is rapidly discharged, thereby quickening the formation of the hydrogen water.

The outer coat member is desirably small in its thickness or in diameter in the portion near a position where the thickness of the ampule member is small.

In the present hydrogen generator mentioned above, since the portion where the thickness of the outer coat member is smaller or thinner is installed in the vicinity of the position near the position where the thickness of the ampule member is small, the position where the outer coat member tends to be folded approximately coincides with the position where the ampule member tends to be ruptured. Therefore, the ampule member further tends to be ruptured and it is possible to achieve the rapid hydrogen gas generation and the hydrogen water formation.

Further, the present hydrogen generator for drinking water may be structured such that an upper end of the outer coat member has a lid member and the aqueous solution within the outer coat member is sealed by the air-permeable and water-impermeable material provided in the lid member, and

the air-permeable and water-impermeable material is a thermoplastic resin.

The thermoplastic resin is preferably at least one kind selected from a group consisting of (A) polyvinylidene chloride, (B) polyvinyl chloride and (C) polyacrylonitrile.

The hydrogen gas generated by the rupture of the ampule member is going to be discharged upward from the lid member in the upper end of the outer coat member.

The present hydrogen generator may be provided with a cap member having in its lower side an opening with a thread groove which can be screw-tightened with a general-purpose bottle, and being set to a bottom portion closing the upper end,

the cap member may have a cap opening portion which protrudes downward from the vicinity of a center of the bottom portion and has an opening being smaller in diameter than the opening of the cap member and being able to be screw-tightened with the upper end of the outer coat member, and

the upper end of the outer coat member may be provided with a thread groove which can be screw-tightened with the cap opening portion.

The present hydrogen generator is structured such as to be attached its upper end to the cap for the general-purpose bottle. More specifically, the aqueous solution in the inner portion can be changed to the hydrogen water in a state in which the cap is tightened to the general-purpose bottle, by providing the cap member which can screw-tighten the outer coat member downward from the bottom portion (a top surface in the case of being open below) of the cap member, inserting the outer coat member into the bottle in a state in which the cap member extends downward to be attached to the outer coat member when using, and fastening the cap member to the bottle. Therefore, the aqueous solution in the general-purpose bottle can be easily changed to the hydrogen water in a normal storage state.

### Advantageous Effects of Invention

The present invention can simply and rapidly obtain the hydrogen water with a simple step. Further, the present invention can be used in any container having a shape and size which is portable and easily carried, and easily form the hydrogen water in the general-purpose bottle.

### BRIEF DESCRIPTION OF DRAWINGS

FIG. 1 is a schematic cross sectional view of an embodiment of a hydrogen generator according to the present invention.

FIGS. 2(a) and 2(b) are schematic views for generating hydrogen by folding the hydrogen generator according to the present invention, in which FIG. 2(a) shows a state in which an outer coat member 12 is folded from a non-used state in FIG. 1, and FIG. 2(b) shows a state in which the outer coat member 12 is turned back to an original state after being folded.

FIGS. 3(a) and 3(b) are schematic cross sectional view showing a state in which the outer coat member 1 is smaller in its thickness or diameter in the vicinity of a center thereof in a longitudinal direction, in which FIG. 3(a) shows a structure in which a convex shape portion protruding inward is provided around an inner wall in the vicinity of the center of the outer coat member, and FIG. 3(b) shows a structure in which a part of an ampule member is provided with a thin portion having a smaller thickness than the other portions.

FIG. 4 is a schematic view of a cap member and the present hydrogen generator.

FIG. 5 schematically shows an example of a granular particle which corresponds to a metallic particle sealed in the outer coat member.

FIG. 6 shows a schematic view showing a state in which the cap member and the present hydrogen generator in FIG. 4 are inserted into a bottle under an installed state.

### DESCRIPTION OF EMBODIMENTS

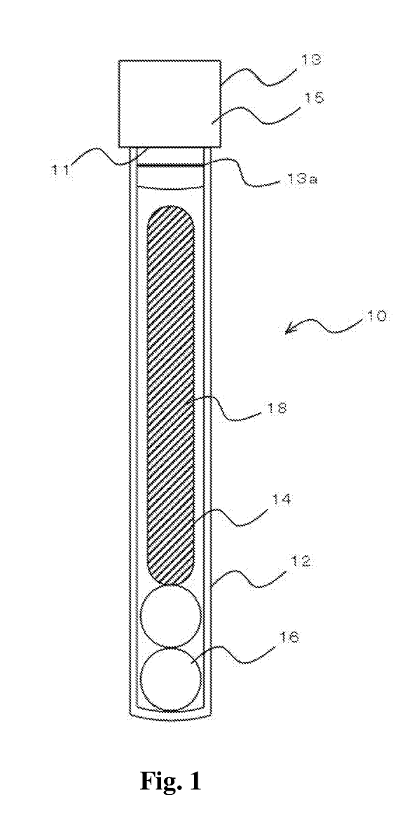

A description will be in detail given below of a representative example of an embodiment of a hydrogen generator according to the present invention with reference to FIGS. 1 to 5. It goes without saying that the hydrogen generator according to the present invention is not limited to the illustrated one, but includes structures which are obtained by modifying the illustrated and described contents within a common sense range. Further, each of the drawings may be displayed by exaggerating dimensions, ratios and numbers as occasion demands for easy understanding.

First of all, a description will be given of an outline of the present hydrogen generator with reference to FIG. 1. FIG. 1 is a schematic cross sectional view of an embodiment of a hydrogen generator 10 according to the present invention. As shown in FIG. 1, in the present hydrogen generator 10, an ampule member 14 and a metal member (a metal material) 16 are sealed in an inner portion of an outer coat member 12. A hydrogen passing member 13 is arranged above the outer coat member 12 (an upper side to the page space), and an aqueous solution 18 is sealed within the ampule member 14.

Subsequently, a description will be in detail given below of each of constituent elements.

The outer coat member 12 is formed into an approximately tubular shape which is open in an upper side thereof and extends in a longitudinal direction. The outer coat member 12 is constructed by a raw material which does not substantially pass the metal member 16 in an inner portion thereof, the aqueous solution 18 and gas such as hydrogen, can be folded or bent by a hand power and has a high flexibility, and is formed generally by a resin material such as rubber. The ampule member 14 and the metal member 16 are sealed by the outer coat member 12 and the hydrogen passing member 13 (a lid member 13 mentioned later) which is connected to an opening portion of the outer coat member 12.

A lid member 15 having an approximately cylindrical cork shape is press-fit into an opening 11 in the upper end of the outer coat member 12, and a film raw material 13a having a thin film shape is provided in a lower surface of the lid member 15. The film raw material 13a is constructed by an air-permeable and water-impermeable material which does not allow passage of the metal and the aqueous solution and allows passage of the gas. Further, the lid member 15 is constructed by a raw material which allows passage of the gas, and hydrogen generated within the outer coat member 12 is discharged outward via the hydrogen passing member 13 which is constructed by the film raw material 13a and the lid member 15.

The lid member 15 of the air-permeable and water-impermeable material 13 is a nonwoven fabric and the film raw material 13a employs a thermoplastic resin, for example, polyvinylidene chloride, polyvinyl chloride or polyacrylonitrile.

The ampule member 14 is formed into an approximately tubular shape (a rod-like member) extending in the longitudinal direction which forms a closed space sealing the aqueous solution mainly containing water. The ampule member 14 has an outer wall made by a raw material such as glass or plastic which is harder than the outer coat member 12 and tends to be ruptured, in the same manner as a general-purpose ampule. Actually, it can be easily ruptured when a hand power is applied thereto in an approximately perpendicular direction with respect to the longitudinal direction without being bent.

Further, since the ampule member 14 has a higher rigidity than the outer coat member 12, the ampule member 14 is ruptured before the outer coat member 12 is ruptured or torn by applying a pressure to the outer coat member 12 in the perpendicular direction with respect to the longitudinal direction, so that the aqueous solution 18 sealed within the ampule member 14 flows out into the outer coat member 12 and is accumulated.

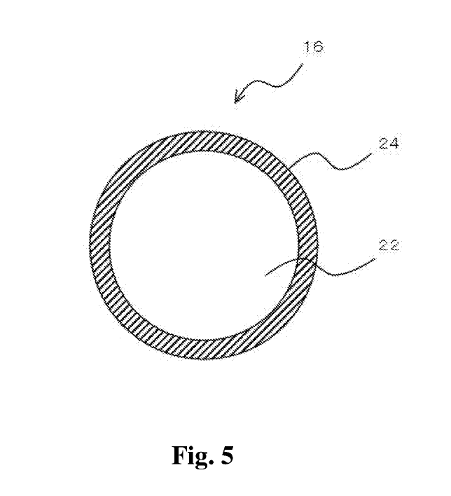

FIG. 5 schematically shows an example of a granular shape as the metal member 16 sealed within the outer coat member 12. Specifically, the metal member 16 is constructed by an approximately spherical non-reaction portion 22 and a metal particle layer 24 which coats and fixed onto a surface thereof, as shown in FIG. 5. The metal particle layer 24 is mainly constituted by the metal which makes hydrogen generation reaction with the water. For example, the metal is magnesium, aluminum, calcium, potassium, sodium, zinc or iron. The non-reaction portion 22 is preferably made of a raw material which does not substantially generate any chemical reaction by contacting with the aqueous solution, for example, plastic or a ceramic ball. The metallic particle 24 is fixed to the surface of the non-reaction portion 22, for example, by baking. As a result, it is possible to always secure a surface area of the metal member 16 which comes into contact with the aqueous solution, aggregation of the metal particles is not occurred when reacting with the aqueous solution 18 in comparison with the case that the metal member 16 is mounted in a powder shape. Thus, it is possible to secure a stable hydrogen generation reaction.

Further, it is possible to employ a something like a cartridge in which the non-reaction portion 24 is applied and decorated with the metallic particles 24, the non-reaction portion being made of the nonwoven fabric or the like for avoiding the aggregation of the metallic particles. Further, in the case that a diameter of the outer coat member 12 is large to some degree or the case that the hydrogen generation reaction is rapidly performed, the powdered metallic particles 24 may be mounted as it is.

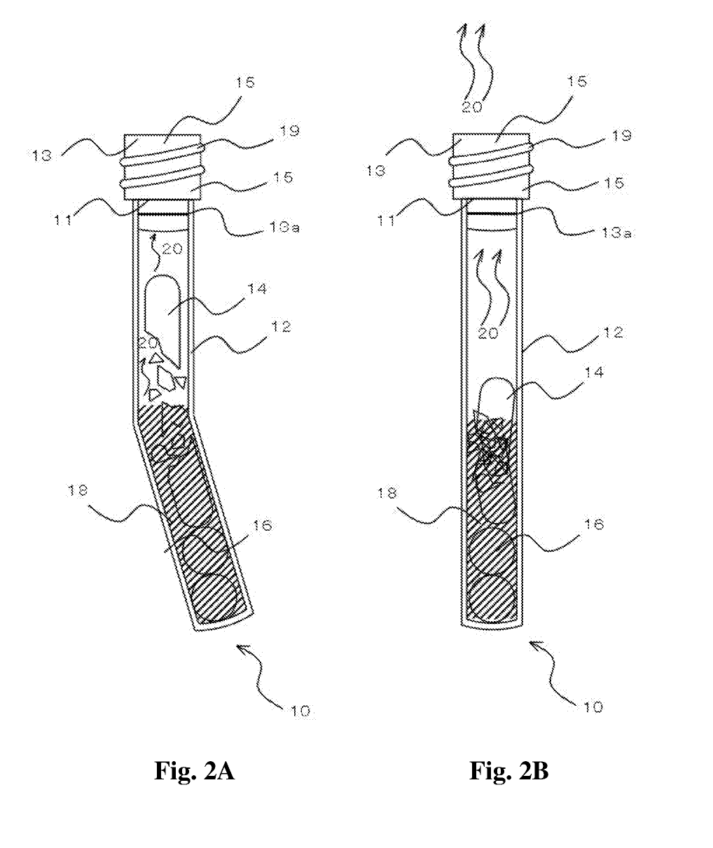

Next, a description will be given of a method of using the present hydrogen generator 10 with reference to FIG. 2. FIG. 2 is a schematic view for generating hydrogen by folding the hydrogen generator 10 according to the present invention, in which FIG. 2(a) shows a state in which the outer coat member 12 is folded from a non-used state in FIG. 1, and FIG. 2(b) shows a state in which the outer coat member 12 is returned to the original state after being folded. When a pressure is applied to the present hydrogen generator 10 in the perpendicular direction with respect to the longitudinal direction, the outer coat member 12 is bent and the ampule member 14 is ruptured as shown in FIG. 2(a). In connection therewith, the aqueous solution 18 within the ampule member 14 flows out into the outer coat member 12, and comes into contact with the metal member 16. Subsequently, the chemical reaction between water and a metal is occurred as shown in FIG. 2(b). As a result, hydrogen 20 is generated, and only the hydrogen gas 20 flows out of the outer coat member 14 to the outside via the film raw material 13a in the lid member 15 in the upper portion. The hydrogen gas 20 flowing out to the outside as mentioned above dissolves into the beverage by putting the present hydrogen generator 10 into a desired beverage, and the user can obtain the beverage (the hydrogen water) into which hydrogen dissolves.

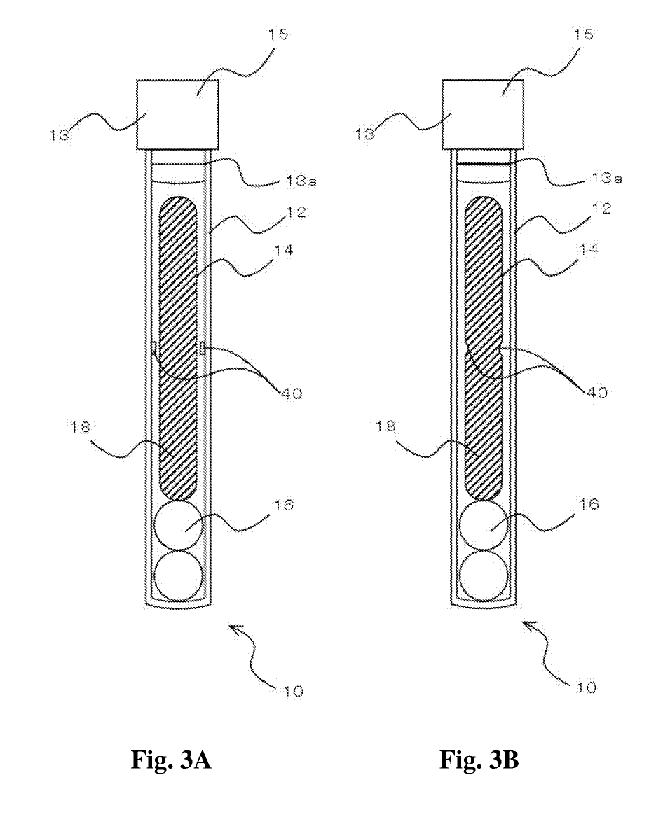

Further, the outer coat member 12 is small in thickness or diameter in the vicinity of the center in the longitudinal direction. For example, in an example of FIG. 3(a), a convex shape portion 40 protruding inward is provided around an inner wall in the vicinity of the center of the outer coat member 12. By provision of the convex shape portion 40, a stress is concentrated to the convex shape portion 40 in the case that a transverse load (pressure) is applied to the present hydrogen generator 10, so that the portion not only tend to be folded but also come into contact with the ampule member 14 in the vicinity of the center in the longitudinal direction, thereby being pressed. As a result, the ampule portion can be more easily ruptured.

In the meanwhile, in an example of FIG. 3(b), a part of the ampule member 14 is provided with a thin portion 41 which has a smaller thickness than in the other portion. Since the thin portion 41 tends to be ruptured in comparison with the other portions, the ampule member 14 is ruptured easily with the smaller transverse load (pressing force). Further, the thin portion 41 is provided in the vicinity of the center of the ampule member 14 in the longitudinal direction, and the aqueous solution 18 rapidly flows out into the outer coat member 12 in comparison with the case that only one end is ruptured. Further, in the case that the convex shape portion 40 of the outer coat member 12 mentioned above is arranged at the approximately same position as the thin portion 41 in the longitudinal direction, the ampule member 14 is more easily ruptured.

The metal member 16 is exemplified by magnesium, aluminum, calcium or hydride thereof, as a main composition which discharges the hydrogen gas, for example, by reacting with water. A grain diameter and a shape of the metal are variously set according to a subject aqueous solution or bottle intending to form the hydrogen water.

The aqueous solution 18 may be provided with dye or flavor, and the user can enjoy the hydrogen water visually and with its odor. Further, it is possible to discriminate whether or not the beverage is the hydrogen water, that is, whether or not the rupturing of the ampule member 14 is well performed and hydrogen is generated.

Next, a description will be given below of the other embodiment of the hydrogen generator according to the present invention.

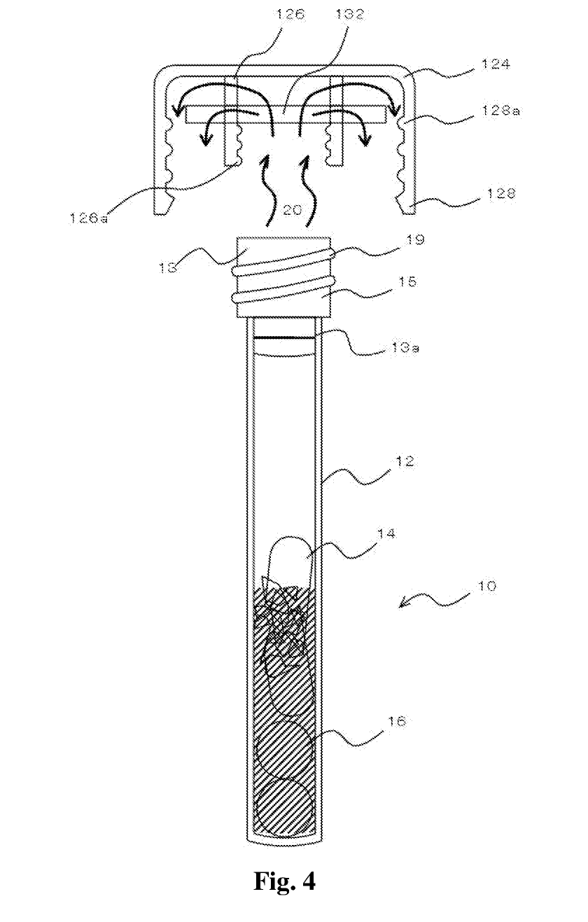

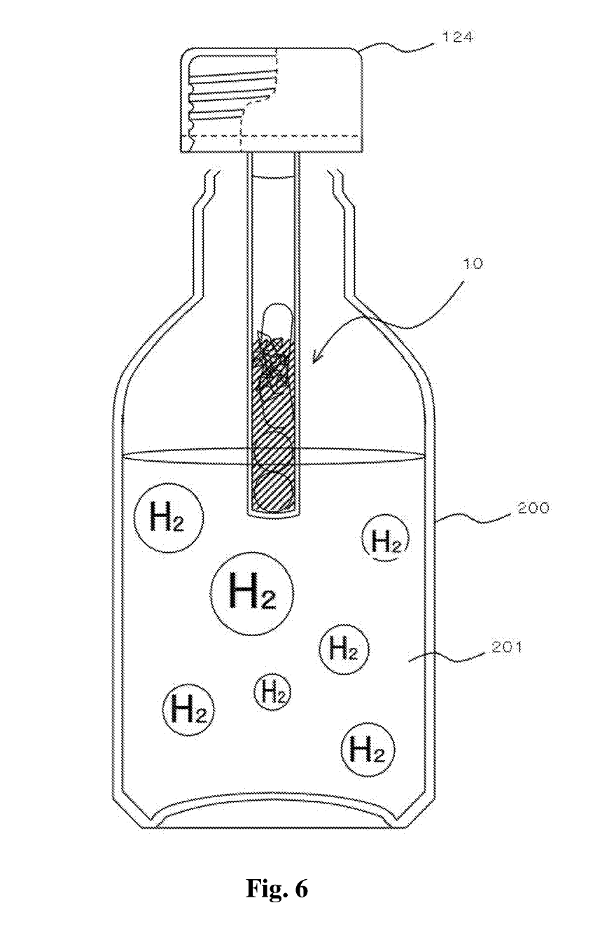

FIG. 4 shows a schematic view of a cap member and the present hydrogen generator 110. FIG. 6 is a schematic view showing a state in which the cap member and the present hydrogen generator 110 in FIG. 4 are inserted into a bottle in an installed state.

The present hydrogen generator 110 is provided with an outer coat member 112, an ampule portion 114, a metal portion 116, an aqueous solution 118 and a hydrogen permeable portion 113 in the same manner as the hydrogen generator 10 mentioned above, and further employs a cap member 122. A hydrogen generating procedure is the same as that of the hydrogen generator 10 mentioned above.

The cap member 122 is an approximately cylindrical member which is open in its lower side, and is constructed by a cap main body portion 124, an inner flange portion 126, an outer flange portion 128 and a filter portion 132. The cap main body portion 124 is formed into an approximately cylindrical shape having an opening in a lower side (a lower side to the page space), and is formed into a cap shape for a rated bottle (the cap can be applied to the existing bottle as it is). The cap member 122 forms an inner and outer two-layered approximately cylindrical opening portion with the inner flange portion 126 and the outer flange portion 128. The approximately cylindrical filter portion 132 is arranged in the vicinity of a center of the inner flange portion 126 in a longitudinal direction (a height direction), at a vertically intermediate position of the inner flange portion 126 approximately in parallel to an upper surface of the cap main body portion 124. The filter portion 132 is provided with an air-permeable and water-impermeable material (for example, a fluorine film) which does not pass a metal and the aqueous solution but passes hydrogen, in a portion where the filter portion 132 is pinched by the inner flange portion 126. A spiral thread groove 126a is arranged in an inner periphery of the inner flange portion below the filter portion 132, and a spiral thread groove 128a is arranged from an upper surface of the cap member 124 in an inner periphery of the outer flange portion 128.

The lid portion 15 of the hydrogen generator 10 shown in FIG. 4 is provided in an outer periphery with a spiral screw head 19 which can be threadably fastened to a screw head 126a of the inner flange portion 126. When the present hydrogen generator 10, the cap member 122 and a bottle 200 are threadably fastened, the hydrogen gas 20 discharged out of the hydrogen generator 10 passes through the filter portion 132 and reaches the aqueous solution 201 within the bottle 200 via a clearance gap between the inner flange portion 126 and the outer flange portion 128. As a result, the hydrogen water can be generated when the bottle 200 is sealed by the cap member 124.

In the example in FIGS. 4 and 6, the filter member 132 provided with the air-permeable and water-impermeable material allows only the gas such as the hydrogen gas from the present hydrogen generator 10 to pass through, the air-permeable and water-impermeable material may not be provided in the hydrogen generator 10 itself. However, since the present hydrogen generator 10 may fall down or the user may put the present hydrogen generator 10 in the bottle 200 as it is, the air-permeable and water-impermeable material is necessarily provided in the hydrogen generator 10 itself.

Further, though FIGS. 4 and 6 show the structure in which the cap member 124 or the like is threadably fastened to the bottle 200 by taking versatility into consideration, however, it may employ a structure which press-fit into the bottle or the hydrogen generator 10 by means of the other mechanism than the screw mechanism.

### REFERENCE SIGNS LIST

10: hydrogen generator
12: outer coat member
13: hydrogen passing member
14: ampule portion
16: metal portion
18: aqueous solution
20: hydrogen
22: non-reaction portion
24: metallic particle
40: convex shape portion
110: hydrogen generator
112: outer coat member
113: hydrogen passing member
114: ampule portion
116: metal portion
118: aqueous solution
122: cap member
124: cap main body portion
126: inner flange portion
128: outer flange portion
130: screw portion

1. A hydrogen generator for beverages, comprising:
an approximately tubular ampule member which seals an aqueous solution having water as a main composition in an inner portion thereof and extends in a longitudinal direction; and
an approximately tubular outer coat member which seals the ampule member and a metal material making hydrogen generation reaction with water in an inner portion thereof, is constructed by a raw material having a higher flexibility than the ampule member and extends in the longitudinal direction of the ampule member,
wherein a part of the outer coat member is shielded from an outside by an air-permeable and water-impermeable material which shields the aqueous solution and allows passage of hydrogen, and
wherein the ampule member is ruptured with a hand power in a lateral direction of the ampule member when using.

2. The hydrogen generator for beverages according to claim 1, wherein the metal material is constructed as a granular material, a powdered material, an optional stereoscopic shape, a metal fixed onto a surface of a non-reactant or a combination thereof.

3. The hydrogen generator for beverages according to claim 1, wherein a main component of metal chemically reacting with water is any one of magnesium, aluminum, and calcium, in the metal member.

4. The hydrogen generator for beverages according to claim 1, wherein a thickness of the ampule member in the vicinity of a center in a longitudinal direction has a smaller structure than the other member.

5. The hydrogen generator for beverages according to claim 4, wherein the outer coat member is small in its thickness or diameter in a portion near a position where the thickness of the ampule member is small.

6. The hydrogen generator for beverages according to claim 1, wherein an upper end of the outer coat member has a lid member and the aqueous solution within the outer coat member is sealed by the air-permeable and water-impermeable material provided in the lid member, and
the air-permeable and water-impermeable material is a thermoplastic resin.

7. The hydrogen generator for beverages according to claim 6, wherein the thermoplastic resin is at least one kind selected from a group consisting of (A) polyvinylidene chloride, (B) polyvinyl chloride and (C) polyacrylonitrile.

8. The hydrogen generator for beverages according to claim 1, further comprising a cap member having in its lower side an opening with a thread groove which can be screw-tightened with a general-purpose bottle, and being set to a bottom portion closing the upper end,
wherein the cap member has a cap opening portion which protrudes downward from the vicinity of a center of the bottom portion and has an opening being smaller in diameter than the opening of the cap member and being able to be screw-tightened with the upper end of the outer coat member, and
wherein the upper end of the outer coat member is provided with a thread groove which can be screw-tightened with the cap opening portion.
